(19) United States
(12) Patent Application Publication
(10) Pub. No.: US 2004/0037930 A1
(43) Pub. Date: Feb. 26, 2004

(54) Process and composition for treating PSE meat or meat with reduced functionalities

(75) Inventor: Heinz Keller, Pittsburgh, PA (US)

Correspondence Address: CANTOR COLBURN, LLP, 55 GRIFFIN ROAD SOUTH, BLOOMFIELD, CT, 06002

(73) Assignee: Rhodia Inc., Cranbury, NJ

(21) Appl. No.: 10/064,809

(22) Filed: Aug. 20, 2002

(51) Int. Cl. A23L 1/31

(52) U.S. Cl. 426/281

(57) ABSTRACT

A composition and processes for treating meat to reduce and or prevent the occurrence of pale, soft, and exudative characteristics in the meat. The composition generally comprises a phosphate compound, a protein, carrageenan, and a hydrocolloid other carrageenan. The composition can be further formulated into a brine solution.

### BACKGROUND OF INVENTION

This disclosure generally relates to processes and compositions for treating meat to reduce or prevent the occurrence of pale, soft, and exudative characteristics.

The terms “pale”, “soft” and “exudative” refer to certain undesirable cosmetic characteristics of cuts or chunks of fresh meat. These terms generally relate to a preference evaluation and do not denote or suggest that such meat is less wholesome, inedible, or unusable. Meat that is developing or that has developed pale, soft, and exudative characteristics is referred to as PSE meat. Another category of meat is that which has dark, firm, and dry or non-exudative characteristics, which can be described as DFD meat. The term “normal” meat as used herein refers to meat which is acceptable in a preference selection and whose characteristics are subjectively generally between PSE meat and DFD meat.

The pale characteristic of PSE meat generally refers to a reduction in color intensity of ground meat or of a fresh cut or chunk of meat. For example, when the fresh meat cut is ham, good color intensity is one wherein the ham has a darkish pink-to-red color. In contrast, a pale ham is one that has a dull and light grayish coloration. Generally speaking, a so-called pale ham is less desirable and is of a lower commercial value than a ham having a more intense coloration.

A cut or chunk of meat exhibiting a soft texture Is one that is not particularly firm. This condition expresses itself in finished pieces of meat, for example, hams, as a quality that makes it difficult to cut such meat into thin slices. The exudative quality of PSE meat refers to the inability of cuts or chunks of meat to hold water.

A pale, soft, and exudative muscle cut or chunk or grind of meat is thus one that has a pale color, soft texture, and a reduced capacity for holding water. In contrast, a cut, chunk, or grind of meat that does not have PSE characteristics has a noticeably darker color and a firmer texture because the muscle protein is believed to be less denatured than in a PSE muscle. A muscle cut or chunk or grind which does not exhibit noticeable PSE characteristics also has a greater water holding capacity so that the moisture remains within the meat, even when cut or sliced, rather than exude from the meat over the passage of time.

A suggested reason for the occurrence of PSE characteristics is that lactic acid is rapidly generated post-mortem in the carcass. The lactic acid is believed to accumulate within the meat components and rapidly lowers the pH of such meat. This fast lactic acid generation and subsequently fast pH lowering is believed to cause or at least contribute to the damaging or denaturing of muscle protein, thereby resulting in the appearance or occurrence of the PSE condition.

While the art describes various methods of preventing the development of PSE characteristics in meat, none of them are believed to describe a procedure for lessening, reversing, or repairing the effects of PSE once it has occurred.

### SUMMARY OF INVENTION

Disclosed herein is a composition and process for treating meat to reduce or prevent the occurrence of pale, soft, and exudative characteristics. The composition for treating a meat product comprises a phosphate compound in an amount of about 5 to about 50 parts by weight based on the total weight of the solids in the composition; a protein compound in an amount of about 5 to about 70 parts by weight based on the total weight of the solids in the composition; a carrageenan in an amount of about 5 to about 50 parts by weight based on the total weight of the solids in the composition; and a hydrocolloid other than carrageenan in an amount of about 1 to about 15 parts by weight based on the total weight of the solids in the composition.

In accordance with another embodiment, a composition consists essentially of: an alkali metal chloride salt in an amount of about 30 to about 80 parts by weight based on the total weight of the solids in the composition; a tripolyphosphate compound in an amount of about 5 to about 50 parts by weight based on the total weight of the solids in the composition, an isolated soy protein compound in an amount of about 5 to about 70 parts by weight based on the total weight of the solids in the composition; a carrageenan in an amount of about 5 to about 50 parts by weight based on the total weight of the solids in the composition; and a hydrocolloid other than carrageenan in an amount of about 1 to about 15 parts by weight based on the total weight of the solids in the composition.

In yet another embodiment, a brine composition for treating a meat product, comprises water; an alkali metal chloride salt in an amount of about 30 to about 80 parts by weight based on the total weight of the solids in the composition; a phosphate compound in an amount of about 5 to about 50 parts by weight based on the total weight of the solids in the composition; a protein compound in an amount of about 5 to about 70 parts by weight based on the total weight of the solids in the composition a carrageenan in an amount of about 5 to about 50 parts by weight based on the total weight of the solids in the composition; and a hydrocolloid other than carrageenan in an amount of about 1 to about 15 parts by weight based on the total weight of the solids in the composition.

A process of treating meat to reduce or prevent the occurrence of pale, soft, and exudative characteristics in the meat comprises applying to the meat a brine solution in an amount effective to reduce or prevent the occurrence of the pale, soft, and exudative characteristics, wherein the brine solution comprises water; an alkali metal chloride salt in an amount of about 30 to about 80 parts by weight based on the total weight of the solids in the composition; a tripolyphosphate compound in an amount of about 5 to about 50 parts by weight based on the total weight of the solids in the composition; an isolated soy protein compound in an amount of about 5 to about 70 parts by weight based on the total weight of the solids in the composition; a carrageenan in an amount of about 5 to about 50 parts by weight based on the total weight of the solids in the composition; and a hydrocolloid other than carrageenan in an amount of about 1 to about 15 parts by weight based on the total weight of the solids in the composition.

A process for treating meat comprising contacting the meat with a treatment solution having a pH greater than about 7, said solution comprising water; an alkali metal chloride salt in an amount of about 30 to about 80 parts by weight based on the total weight of the solids in the composition; a phosphate compound in an amount of about 5 to about 50 parts by weight based on the total weight of the solids in the composition; a protein compound in an amount of about 5 to about 70 parts by weight based on the total weight of the solids in the composition; a carrageenan in an amount of about 5 to about 50 parts by weight based on the total weight of the solids in the composition; and a hydrocolloid other than carrageenan in an amount of about 1 to about 15 parts by weight based on the total weight of the solids in the composition, said treatment being conducted for a period of time effective to reduce an average freeze/thaw loss to less than 10%.

### DETAILED DESCRIPTION

Disclosed herein are compositions and processes for treating meat to reduce the occurrence of PSE characteristics or meat with reduced functionalities similar to PSE meat, e.g., mechanical deboned meat. The composition for treating the meat preferably comprises a phosphate, a protein and/or starch, carrageenan, and at least one additional hydrocolloid other than the aforementioned carrageenan. Preferably, the composition is formulated into a brine solution for application to the meat. Suitable meats include, but are not intended to be limited to, poultry (e.g., turkey, chicken, or the like), pork, (e.g., ham), loafs, meat mixtures comprising at least one of these meats, and the like.

The phosphates are preferably alkali metal or alkaline earth metal salts of phosphoric acid and its derivatives. More specifically, the phosphates are preferably selected from a group of orthophosphates including mono-basic, di-basic and tri-basic orthophosphates, pyrophosphates including acid pyrophosphates, polyphosphates including tripolyphosphates, tetrapolyphosphates and higher polyphosphates, metaphosphates including tetrametaphosphates and hexametaphosphates, and the like. The phosphates have been found to be effective in dissolving intact muscle proteins, e.g., actin and myosin, as antioxidative agents and may additionally function in adjusting the pH of the brine solution. As previously noted, post mortem lactic acid build-up in the meat tissue is believed to be a causal factor of PSE. Reducing the acidity in the meat associated with the lactic acid can help reduce, repair, and/or prevent the occurrence of PSE.

Examples of specific phosphate salts that are preferably selected for the composition include potassium- or sodium orthophosphate, potassium- or sodium hexametaphosphate, potassium- or sodium acid pyrophosphate, and combinations comprising at least one the foregoing phosphates. In a preferred embodiment, the phosphate is a sodium tripolyphosphate of the formula Na₅P₃O₁₀, which can be obtained commercially from Rhodia, Inc. under the trademark CURAFOS STPP. In practice, the phosphates are preferably employed in an amount of about 5 to about 50 about parts by weight of the total solids in the composition, with about 10 to about 30 parts by weight of the total solids in the composition more preferred, and with about 10 to about 25 parts by weight of the total solids in the composition even more preferred.

Suitable proteins include animal or vegetable based proteins or mixtures thereof (e.g., whey proteins, soy proteins, dehydrated muscle proteins, pork skin proteins, blood proteins, pea proteins and the like). In a preferred embodiment, the proteins are soy proteins and more preferably, soy protein isolates (also referred to as isolated soy protein), which are preferably at least 90% protein on a moisture-free basis. Isolated soy protein consists of highly refined proteins extracted from dehulled and defatted soybeans with water or mild alkali. During the extraction process, the fiber is removed and the extract is preferably adjusted to a pH of about 4.5 to precipitate and collect the protein. Soluble carbohydrates, including oligosaccharides, are then removed. The resulting product is referred to by those skilled in the art as an isoelectric isolate. The isolate is preferably neutralized to a sodium or a potassium salt to render the isolate more soluble.

The proteins, and in particular isolated soy proteins, are preferably employed in an amount of about 5 to about 70 parts by weight of the total solids in the composition, with about 10 to about 50 parts by weight of the total solids in the composition more preferred, and about 15 to about 40 parts by weight of the total solids in the composition even more preferred.

The starch is preferably a native starch and is employed in an amount of about 5 to about 70 parts by weight of the total solids in the composition, with about 10 to about 50 parts by weight of the total solids in the composition more preferred, and about 15 to about 40 parts by weight of the total solids in the composition even more preferred.

In compositions containing both the protein and the starch, it is preferred that the combined amounts comprise about 5 to about 70 parts by weight of the total solids in the composition, with about 10 to about 50 parts by weight of the total solids in the composition more preferred, and about 15 to about 40 parts by weight even more preferred.

The carrageenan employed in the composition can be any form including, but not limited to, kappa, iota, lambda, and combinations comprising at least one of these forms. The various forms differ in the number and location of sulfate ester substitution. In a preferred embodiment, the carrageenan is a kappa-carrageenan. Suitable carrageenans are commercially available under the trademark MEYPROGEL from Rhodia, Inc.

Carrageenan is preferably added to the composition in an amount of about 5 to 50 about parts by weight of the total solids in the composition, with about 15 to 35 about parts by weight of the total solids in the composition more preferred, and about 20 to about 30 parts by weight of the total solids in the composition even more preferred.

The additional hydrocolloids in the composition are preferably water-soluble polymers that provide texturizing, stabilizing, and/or gelling to the meat products. Suitable hydrocolloids for use in the composition include alginates, agar, konjak, cellulose derivatives, tara gum, pectins, gellan gum, guar gum, locust bean gum, xanthan gum, and combinations comprising at least one of the foregoing hydrocolloids. Of these, locust bean gum, guar gum, and combinations comprising guar gum and/or locust bean gum are most preferred.

The additional hydrocolloid is preferably added to the composition in an amount of about 1 to 15 about parts by weight of the total solids in the composition, with about 1 to 10 about parts by weight of the total solids in the composition more preferred, and about 2 to about 8 parts by weight of the total solids in the composition even more preferred.

Locust bean gum, also referred to as LBG, Carob, or Carob Gum, is a polysaccharide derived from the endosperm of the Locust Bean (ceratonia siliqua). Structurally, locust bean gum is a galactomannan similar in structure to guar gum consisting of a (1,4)-linked b-D-mannopyranose backbone with branchpoints from the 6-positions linked to a-D-galactose (i.e., 1,6-linked a-D-galactopyranose). There are preferably about 2.8 to about 4.9 mannose residues for every galactose residue.

As previously discussed, guar gum is a galactomannan similar to locust bean gum consisting of a (1,4)-linked b-D-mannopyranose backbone with branchpoints from their 6-positions linked to a-D-galactose (i.e., 1,6-linked-a-D-galactopyranose). There are preferably between about 1.5 to about 2 mannose residues for every galactose residue.

The guar gum may be native or depolymerized. Preferably, the guar gum employed in the composition is depolymerized. The term depolymerized refers to material having reduced molecular weight relative to the natural substance. Depolymerized material may be obtained by the breaking of bonds in the polysaccharide main chain to produce a range of shorter chains that are substantially chemically identical with the native material other than in molecular weight. The depolymerized material may have a broad distribution of molecular weights. Depolymerization may be effected in a number of ways including, but not limited to, chemical treatment and physical treatment or a combination of such treatments to bring about cleavage of the polymer and may take place though a random or a chain process.

Depending on the type of meat product (e.g., turkey, pork, etc.) and desired texture (e.g., ground, minced, strips, whole, etc.), the composition may further include other additives such as, for example, other antibacterial and/or chelating agents, natural or synthetic seasonings and/or flavors, dyes and/or colorants, vitamins, preservatives, minerals, nutrients, enzymes, other animal or vegetable proteins, starch, antioxidants such as sodium ascorbate, and sodium erthyrobate, pH adjusters such as sodium bicarbonate, salts such as potassium- or sodium chloride, potassium- or sodium nitrate, potassium- or sodium nitrite, or like additives. A preferred additive is sodium erythrobate, which is an antioxidant similar to Vitamin C, and is made from sugar.

The process generally comprises applying the composition, in dry or liquid form, to the meat. In the liquid or dry form, the composition may be mixed with the meat, sprayed, massaged, brushed, rubbing, or applied by one or more of the foregoing application methods. For example, mixing may be accomplished with tumblers. Tumblers, i.e., barrel mixers, are tanks with baffles that can hold up to many tons of injected meat. During slow rotation of the tumbler the brine is massaged into the meat for optimal distribution, and the salt- and phosphate soluble meat proteins are extracted and give the meat pieces a very sticky surface. Tumbling is done under vacuum and can last from few hours to more than 24 hours depending on the type of product. Temperature has to be kept low—preferably below 5° C.

After tumbling the meat is wrapped in a plastic film and put into moulds. Cooking is done until a desired internal temperature is reached. The cooking process and the final internal temperature has an impact on the water holding capacity of the meat proteins, i.e. the cooking loss. A high final internal temperature is desired for microbiological reasons. However, the higher the temperature the higher the cooking loss, which can to some extent be counter acted by other functional ingredients from the brine.

In liquid form, the composition may be further applied by injection directly into or onto the meat tissue. Injection is done with multi-needle injectors. The meat is passed one or more times through the injector until the desired level of injection is reached. The purpose of the injection is to distribute the components of the composition as effectively as possible throughout the meat. It has unexpectedly been found that the components within the composition provide a synergistic effect for lessening, reversing, and/or repairing as well as preventing the occurrence or extent of PSE in cut, chunk, or minced meat.

In a preferred embodiment, the composition, in liquid form, is formulated into a brine solution. Preferably, the brine solution comprises an alkali metal chloride salt in addition to the foregoing components previously described. Suitable alkali metal salts include potassium and sodium chloride. The alkali metal chloride salt is preferably about 30 to about 80 percent based on the total weight of the solids in the composition, with about 40 to about 70 percent more preferred, and with about 45 to about 65 percent even more preferred. The phosphates are preferably employed in an amount of about 5 to about 50 about parts by weight of the total solids in the composition, with about 10 to about 30 parts by weight of the total solids in the composition more preferred, and with about 10 to about 25 parts by weight of the total solids in the composition even more preferred. The proteins, and in particular isolated soy proteins, are preferably employed in an amount of about 5 to about 70 parts by weight of the total solids in the composition, with about 10 to about 50 parts by weight of the total solids in the composition more preferred, and about 15 to about 40 parts by weight of the total solids in the composition even more preferred. The starch is preferably a native starch and is employed in an amount of about 5 to about 70 parts by weight of the total solids in the composition, with about 10 to about 50 parts by weight of the total solids in the composition more preferred, and about 15 to about 40 parts by weight of the total solids in the composition even more preferred. In compositions containing both the protein and the starch, it is preferred that the combined amounts comprise about 5 to about 70 parts by weight of the total solids in the composition, with about 10 to about 50 parts by weight of the total solids in the composition more preferred, and about 15 to about 40 parts by weight even more preferred. The carrageenan in the brine composition is preferably in an amount of about 5 to 50 about parts by weight of the total solids in the composition, with about 15 to 35 about parts by weight of the total solids in the composition more preferred, and about 20 to about 30 parts by weight of the total solids in the composition even more preferred. The additional hydrocolloid in the brine composition is preferably in an amount of about 1 to 15 about parts by weight of the total solids in the composition, with about 1 to 10 about parts by weight of the total solids in the composition more preferred, and about 2 to about 8 parts by weight of the total solids in the composition even more preferred.

The concentration of the brine solution is preferably about 5 to about 50 percent total solids with the remainder water, with about 8 to about 30 percent total solids more preferred, and with about 10 to about 20 percent total solids even more preferred.

The disclosure is further illustrated by the following non-limiting example.

In this example, aqueous brine solutions for treating meat were prepared as shown in Table 1. The particular meat employed was whole pork ham top muscle maintained at a temperature of about 36° to about 40° Fahrenheit. The individual components of the brine solution were added to water at the amounts shown and stirred until a solution was obtained. As much brine solution as possible was then injected into the whole pork ham muscle and additional brine solution was then mixed with the meat to obtain a final ratio of about 55 parts brine to 45 parts meat. Once injected or added to the meat, the meat was placed in a barrel mixer under vacuum. For six hours, the barrel mixer was alternately rolled and rested for about 30-minute cycles. At the end of the six hours, the mixture was rested for six hours and the process repeated one more time. The meat mixture was placed under vacuum and pressed. The meat mixture was then cooked at 167° C. to obtain a core temperature of 160° C., followed by cooling for 24° hours at a temperature of about 2° to about 4° centigrade. The meat was evaluated for yield before cooking, average cooking loss, pH, average freeze/thaw loss, slicability, taste, and color.

Yield before cooking is a measurement of the amount of brine retained by the meat and is expressed as a percentage based on the weight of the meat before and after brine processing. Average cooking loss was obtained by measuring the weight of the meat sample before and after cooking. Average freeze/thaw loss was obtained by freezing the meat sample followed by thawing for 1 cycle. The average freeze/thaw loss provides a measure of its exudative characteristics. The results are shown in Table 2.

TABLE 1

| Component | A* | B* | C | D | E | F |
|---|---|---|---|---|---|---|
| Water | 83.89 | 85.16 | 85.02 | 85.02 | 88.40 | 88.40 |
| NaCl | 6.48 | 6.48 | 6.48 | 6.48 | 6.48 | 6.48 |
| Dextrose | 8.03 | 5.64 | — | — | — | — |
| Sodium erythrobate | 0.14 | 0.14 | 0.14 | 0.14 | 0.14 | 0.14 |
| Sodium nitrite | 0.04 | 0.04 | 0.04 | 0.04 | 0.04 | 0.04 |
| Sodium tripolyphosphate | 1.41 | 1.41 | 1.39 | 1.39 | 1.39 | 1.39 |
| Carrageenan | — | 1.13 | 1.13 | 1.13 | 1.13 | 1.13 |
| Native starch | — | — | 5.64 | 5.21 | — | — |
| Locust bean gum | — | — | 0.28 | 0.28 | 0.28 | 0.28 |
| Guar gum | — | — | — | 0.28 | — | 0.28 |
| Isolated soy protein | — | — | — | — | 2.25 | 1.97 |

*comparative examples

TABLE 2

| | A* | B* | C | D | E | F |
|---|---|---|---|---|---|---|
| pH (brine formulation) | 7.67 | 7.64 | 7.50 | 7.53 | 7.48 | 7.40 |
| pH(meat) | 5.99 | 5.99 | 5.99 | 5.99 | 5.99 | 5.99 |
| pH (meat after mixing) | 6.35 | 6.42 | 6.40 | 6.37 | 6.35 | 6.38 |
| Yield before cooking (%) | 138.0 | 137.7 | 133.9 | 136.4 | 145.5 | 139.6 |
| Average cooking loss (%) | 3.5 | 2.0 | 1.5 | 1.6 | 1.0 | 0.9 |
| Average freeze/thaw loss (%) | 12.62 | 11.21 | 8.92 | 9.99 | 9.58 | 8.87 |

The results show that formulations C, D, E, and F exhibited better yields before cooking compared to control formulations A, and B, suggesting better retention and take up of the brine solution. The average cooking loss was less than 1 percent, indicating that moisture is retained during the cooking cycle. It is noted that average cooking loss results are based on meat yields before cooking. Thus, even though formulations E and F retained or took up more brine, the cooking losses were surprisingly lower than the control formulations. Moreover, the average freeze/thaw losses for formulations C, D, E, and F were significantly better than control formulations A and B.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A composition for treating a meat product, the composition comprising:
a phosphate compound in an amount of about 5 to about 50 parts by weight based on the total weight of the solids in the composition;
a protein compound in an amount of about 5 to about 70 parts by weight based on the total weight of the solids in the composition;
a carrageenan in an amount of about 5 to about 50 parts by weight based on the total weight of the solids in the composition; and
a hydrocolloid other than carrageenan in an amount of about 1 to about 15 parts by weight based on the total weight of the solids in the composition.

2. The composition according to claim 1, wherein the carrageenan is selected from the group consisting of kappa-carrageenan, iota-carrageenan lambda-carrageenan, and combinations containing at least one of the foregoing carrageenans.

3. The composition according to claim 1, wherein the protein comprises a vegetable protein, an animal protein, and combinations containing at least one of the foregoing proteins.

4. The composition according to claim 1, wherein the protein is an isolated soy protein.

5. The composition according to claim 1, wherein the carrageenan is kappa carrageenan.

6. The composition according to claim 1, wherein the phosphate compound is selected from the group consisting of mono-basic, di-basic, and tri-basic orthophosphates, pyrophosphates polyphosphates, metaphosphates, and combinations containing one of the foregoing phosphates.

7. The composition according to claim 1, wherein the hydrocolloid is a guar gum, a locust bean gum or a combination containing the locust bean gum and the guar gum.

8. The composition according to claim 1, further comprising a native starch compound in an amount of about 5 to about 70 parts by weight based on the total weight of the solids in the composition.

9. The composition according to claim 1, further comprising a native starch compound, wherein a total amount of the native starch and the protein is about 5 to about 70 parts by weight of the total solids in the composition.

10. The composition according to claim 1, wherein the hydrocolloid is selected from the group consisting of alginates, agar, konjak, cellulose derivatives, tara gum, pectins, gellan gum, guar gum, locust bean gum, xanthan gum, and combinations containing at least one of the foregoing hydrocolloids.

11. A brine composition for treating a meat product, the brine composition comprising:
water;
an alkali metal chloride salt in an amount of about 30 to about 80 parts by weight based on the total weight of the solids in the composition; a phosphate compound in an amount of about 5 to about 50 parts by weight based on the total weight of the solids in the composition;
a protein compound in an amount of about 5 to about 70 parts by weight based on the total weight of the solids in the composition;
a carrageenan in an amount of about 5 to about 50 parts by weight based on the total weight of the solids in the composition; and
a hydrocolloid other than carrageenan in an amount of about 1 to about 15 parts by weight based on the total weight of the solids in the composition.

12. A composition consisting essentially of:
an alkali metal chloride salt in an amount of about 30 to about 80 parts by weight based on the total weight of the solids in the composition;
a tripolyphosphate compound in an amount of about 5 to about 50 parts by weight based on the total weight of the solids in the composition;
an isolated soy protein compound in an amount of about 5 to about 70 parts by weight based on the total weight of the solids in the composition;
a kappa carrageenan in an amount of about 5 to about 50 parts by weight based on the total weight of the solids in the composition; and
a hydrocolloid other than carrageenan in an amount of about 1 to about 15 parts by weight based on the total weight of the solids in the composition.

13. A process of treating meat to reduce the occurrence of pale, soft, and exudative characteristics in the meat, the process comprising:
applying to the meat a brine solution in an amount effective to reduce or prevent the occurrence of the pale, soft, and exudative characteristics, wherein the brine solution comprises water; an alkali metal chloride salt in an amount of about 30 to about 80 parts by weight based on the total weight of the solids in the composition; a tripolyphosphate compound in an amount of about 5 to about 50 parts by weight based on the total weight of the solids in the composition; an isolated soy protein compound in an amount of about 5 to about 70 parts by weight based on the total weight of the solids in the composition; a carrageenan in an amount of about 5 to about 50 parts by weight based on the total weight of the solids in the composition; and a hydrocolloid other than carrageenan in an amount of about 1 to about 15 parts by weight based on the total weight of the solids in the composition.

14. The process according to claim 13, wherein the meat is selected from the group consisting of poultry, pork, beef, and combinations containing at least one of the foregoing meats.

15. The process according to claim 13, wherein the brine solution is applied by mixing an aqueous solution of the composition with the meat.

16. The process according to claim 13, wherein the brine solution is applied by injection into the meat.

17. The process according to claim 13, further comprising lowering the pH to below about 7.

18. A process for treating meat to reduce the occurrence of pale, soft, and exudative characteristics in the meat, comprising contacting the meat with a treatment solution having a pH greater than about 7, said solution comprising water; an alkali metal chloride salt in an amount of about 30 to about 80 parts by weight based on the total weight of the solids in the composition; a phosphate compound in an amount of about 5 to about 50 parts by weight based on the total weight of the solids in the composition; a protein compound in an amount of about 5 to about 70 parts by weight based on the total weight of the solids in the composition; a carrageenan in an amount of about 5 to about 50 parts by weight based on the total weight of the solids in the composition; and a hydrocolloid other than carrageenan in an amount of about 1 to about 15 parts by weight based on the total weight of the solids in the composition, said treatment being conducted for a period of time effective to reduce an average freeze/thaw loss to less than 10%.

19. The process according to claim 15, wherein the meat is treated at a temperature of about 30° to about 40° Farenheight.
